(19) United States
(12) Patent Application Publication
(10) Pub. No.: US 2025/0221582 A1
(43) Pub. Date: Jul. 10, 2025

(54) Portable Self-Sustained Coin-Operated Shower Device and Method of Use

(71) Applicant: Adam Hessman, Dodge City, KS (US)

(72) Inventor: Adam Hessman, Dodge City, KS (US)

(21) Appl. No.: 18/905,628

(22) Filed: Oct. 3, 2024

Related U.S. Application Data
(60) Provisional application No. 63/619,479, filed on Jan. 10, 2024.

(51) Int. Cl. A47K 3/28; G07F 17/18

(52) U.S. Cl. CPC A47K 3/281; G07F 17/18

(57) ABSTRACT

A self-sustained, portable, coin-operated shower device is disclosed. The device comprises a cylindrical shower unit, an integrated coin-operated access unit that allows entry of a user in the shower unit upon coin insertion therein. The device includes a solar panel located on the control unit, which powers various components including a water heater and UV sanitization light. Water used during showering is drained into a used water tank, filtered through multiple stages including reverse osmosis, and then stored in a fresh water tank for reuse. The shower unit also features adjustable LED lighting, temperature control, a fold-down seat, and handrails to assist elderly or disabled users.

### CROSS-REFERENCE TO RELATED APPLICATION

The present application claims priority to, and the benefit of, U.S. Provisional Application No. 63/619,479 which was filed on Jan. 10, 2024 and is incorporated herein by reference in its entirety.

### FIELD OF THE INVENTION

More specifically, the present invention pertains to a self-sustained portable coin-operated shower device that integrates advanced water recycling technologies with solar power to deliver a comprehensive bathing solution. The device features a cylindrical shower unit constructed from durable, lightweight materials and incorporates a solar-powered control unit that manages water heating, filtration, and sanitization processes. The invention addresses the critical needs of individuals in remote areas, temporary outdoor gatherings, or military operations, providing access to clean and private shower facilities. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, clean water is a fundamental need for maintaining hygiene. However, populations in remote or desolate areas often face severe difficulties in obtaining clean water for bathing. The lack of clean water often leads to the use of contaminated or polluted water sources, which can result in a proliferation of waterborne diseases. The health risks associated with bathing in contaminated water can include various skin diseases, gastrointestinal disorders, and other infections.

Furthermore, at multi-day outdoor events such as music festivals or camps, attendees frequently encounter the absence of adequate shower facilities. The lack of hygiene over several days can lead to the development of unpleasant body odors and the spread of bacteria among the crowd, which can affect overall experience and health. Military operations in remote locations also require portable hygiene solutions. Soldiers operating away from base camps are often unable to maintain regular personal hygiene due to the lack of facilities, leading to decreased morale, increased vulnerability to sickness, and the spread of disease among the troops. People desire a portable, efficient, and self-sufficient showering solution that can provide a sanitary and satisfying user experience.

Therefore, there exists a long-felt need in the art for a hygienic, portable shower solution that addresses the scarcity of clean water and the absence of bathing facilities in remote environments. Additionally, there is a long-felt need in the art for a system that can provide a reliable and comfortable shower experience at temporary gatherings where traditional infrastructure is unavailable. Furthermore, there is a long-felt need for a shower device that is environmentally friendly, utilizes renewable energy sources and recycles water to minimize waste. Moreover, there is a long-felt need in the art for a shower system that can be easily transported and quickly deployed, ensuring access to hygiene facilities wherever and whenever needed. Finally, there is a long-felt need for a system that ensures the safety and privacy of its users while being simple to operate and maintain under varying environmental conditions.

The subject matter disclosed and claimed herein, in one embodiment thereof, comprises a self-sustained portable coin-operated shower device designed to efficiently utilize limited water resources while providing a complete shower experience. The device includes a cylindrical shower unit made from lightweight, water-resistant. A solar panel is mounted on a control unit and powers the device, including a water heater and a UV light for sanitization, making the device fully operational without external power sources. A coin-operated mechanism provides controlled access and an internal recycling system treats and reuses water through a multi-stage filtration process, including reverse osmosis, minimizing water waste.

In this manner, the portable coin-operated shower device of the present invention accomplishes all of the foregoing objectives and provides a novel solution that enhances hygiene in remote and underserved areas. Further, the device enables water to be reused for bathing with minimal loss through a filtration process that utilizes reverse osmosis. In addition, the device allows users to transport the system to needed areas for bathing where water is scarce or where on-site bathing is typically unavailable. The device also reduces the spread of severe sickness and illness due to lack of bathing or bathing in contaminated water.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable shower device. The device comprises a cylindrical shower unit having an interior space to accommodate a user, a door configured with a secure locking mechanism to maintain privacy, at least one handrail and a detachable fold-down seat within the shower unit to assist users, a coin-operated access unit which includes a coin slot for receiving a coin to unlock the door and activate the water supply system, a solar panel disposed on a control unit of the shower device to generate electrical power from solar energy, and a water recycling system including a used water tank, a fresh water tank, multiple stages of filtration including reverse osmosis, and conduits for transferring water between said tanks and to a shower head.

In another embodiment, a self-sustained shower system is disclosed. The self-sustained shower system includes a shower unit equipped with a water heater and an adjustable shower head, a control unit includes operational controls and a coin-operated mechanism for user access. A solar panel system is configured to convert solar energy into electrical power sufficient to operate the water heater, the operational controls, and a UV light for sanitization. A water recycling system is configured to filter and reuse water and comprises a used water tank, a fresh water tank, a reverse osmosis filter, and a secondary filtering system for maintaining hygiene.

In still another embodiment, a method for operating a coin-operated shower device is described. The method includes the steps of loading a clean water tank with water, inserting a coin into a coin slot of a coin-operated access unit to unlock a door of a shower unit and activate a water supply, selecting a desired water temperature using a water temperature control located within the shower unit, using the shower for a predetermined duration or until the water supply is depleted, draining used water through floor grates into a used water tank, filtering the used water through multiple filtration stages including reverse osmosis, transferring the filtered water to a fresh water tank, and activating a UV light to sanitize the shower unit after use.

In still another aspect, a portable, self-sustained coin-operated shower device is disclosed. The device comprises a cylindrical shower unit with an interior adapted for user access and equipped with a locking door, one or more handrails, a fold-down seat, and LED lighting. A coin-operated access unit with a coin slot enables user entry and operation of the device. A control unit is configured with a solar panel to generate and store electrical power used to operate a water heater, a UV light for sanitization, and other operational controls. A water system includes a used water tank and a fresh water tank interconnected by conduits, with water being cycled through a reverse osmosis filter and a secondary filter system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of self-sustained portable coin-operated shower device of the present invention in accordance with the disclosed structure;

FIG. 2 illustrates a perspective view showing the inner connections between different components of the coin-operated shower device of the present invention in accordance with the disclosed structure;

FIG. 3 illustrates a flow chart depicting a process of operation of the self-sustained portable coin-operated shower device of the present invention in accordance with the disclosed structure; and

FIG. 4 illustrates a perspective view of another coin operated access unit which can be integrated to the shower device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a hygienic, portable shower solution that addresses the scarcity of clean water and the absence of bathing facilities in remote environments. Additionally, there exists a long-felt need in the art for a system that can provide a reliable and comfortable shower experience at temporary gatherings where traditional infrastructure is unavailable. Furthermore, there is a long-felt need for a shower device that is environmentally friendly, utilizes renewable energy sources and recycles water to minimize waste. Moreover, there is a long-felt need in the art for a shower system that can be easily transported and quickly deployed, ensuring access to hygiene facilities wherever and whenever needed. Finally, there is a critical need for a system that ensures the safety and privacy of its users while being simple to operate and maintain under varying environmental conditions.

The present invention, in one exemplary embodiment, is a portable, self-sustained coin-operated shower device. The device comprises a cylindrical shower unit with an interior adapted for user access and equipped with a locking door, one or more handrails, a fold-down seat, and LED lighting. A coin-operated access unit with a coin slot enables user entry and operation of the device. A control unit is configured with a solar panel to generate and store electrical power used to operate a water heater, a UV light for sanitization, and other operational controls. A water system includes a used water tank and a fresh water tank interconnected by conduits, with water being cycled through a reverse osmosis filter and a secondary filter system.

Reference will now be made in detail to the present preferred embodiments of the invention, examples of which are illustrated in the accompanying drawings. Wherever possible, the same reference numerals are used in the drawings and the description to refer to the same or like parts.

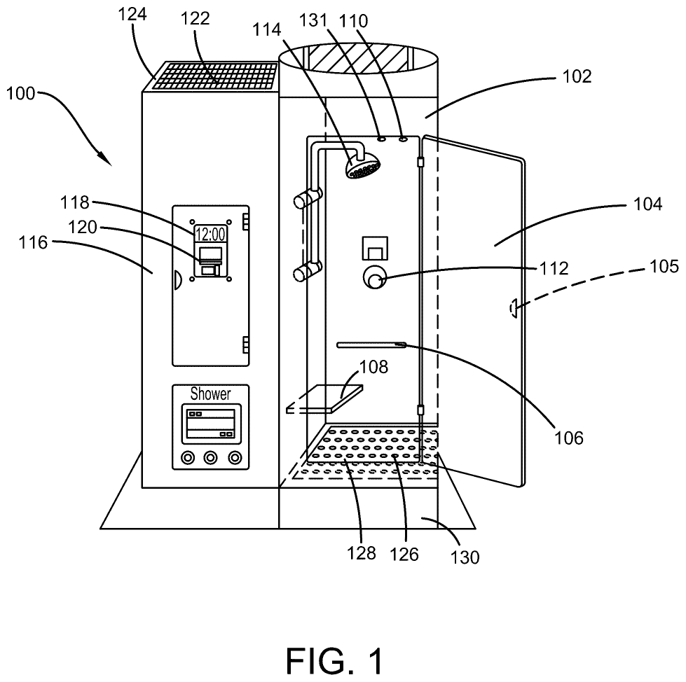

Referring initially to the drawings, FIG. 1 illustrates a perspective view of portable self-sustained coin-operated shower device 100 of the present invention in accordance with the disclosed structure. The portable self-sustained coin-operated shower device 100 of the present invention is designed as a portable shower unit which can be used when water sources are low, contaminated, or unavailable. More specifically, the coin-operated shower device 100 is activated by inserting a coin (of any size, shape, and type), which unlocks the shower device 100 and allows access to a user. The coin-operated shower device 100 includes a cylindrical shower unit 102 which provides space to a user for shower within. The shower unit 102 is preferably made from lightweight, water-resistant materials such as fiberglass, acrylic, or reinforced plastic for durability and ease of cleaning. The shower unit 102 includes at least one door 104 with at least one secure locking mechanism 105 for maintaining privacy of a user taking shower inside the shower unit 102. The locking mechanism 105 can include but is not limited to a combination lock, a locking latch, a key lock, a dial lock, a digital lock, a biometric lock, an electronic smart lock, or any other lock type known in the art. The mechanism 105 is preferably positioned on a rear surface of a door 104 of the device 100 such that only a user inside the device 100 can access the mechanism 105. In one embodiment, the shower unit 102 is made from a ventilated material to prevent steam buildup and promote air circulation.

The shower unit 102 also includes at least one handrail 106 of any type and configuration. The unit 102 is also comprised of at least one fold-down seat 108. In one embodiment, the seat 108 is detachable. The seat 108 is used to assist elderly or disabled users in the shower unit 102 while seated or otherwise positioned. A plurality of LED lights 110 are disposed inside the shower unit 102 for providing illumination while providing safety and consuming minimal electric power. The lights 110 may illuminate any color and have a plurality of brightness levels.

A water temperature control 112 allows a user to control temperature of water dispensed in the shower unit 102 is disposed in the shower unit 102. The water temperature control 112 is positioned at an easily accessible location inside the shower unit 102. The control 112 may be any type such as but not limited to a turning handle, a digital display, etc. At least one shower head 114 is disposed in the shower unit 102 for providing shower water to a user. The shower head 114 may be fixedly attached to the unit and may be adjustable or non-adjustable. In another embodiment, the shower head 114 is detachable. The shower head 114 is internally connected to a water supply 134, such as but not limited to a water tank. The shower head 114 can be in any shape, size, and design and configuration.

A control unit 116 is integrated to the shower unit 102 and can be accessed independently of the shower unit 102 (i.e., from outside of the unit 102). The control unit 116 is adapted to includes a plurality of operational controls for controlling operation of the shower device 100 as described later in the disclosure. A coin operated access unit 118 is adapted to provide access to the shower unit 102 to a user. More specifically, user access to the unit 102 is provided when a coin is inserted into a coin slot 120 of the coin operated access unit 118. Different components such as the shower head 114, water heater 132, locking mechanism 105, etc. may only become operational once a coin is inserted into the unit 118. In one embodiment, the unit 118 may be any type of payment unit such as but not limited to a token-operated access unit, a credit card reader access unit, etc.

For providing electrical power to the shower device 100 for operating various electrical components, a solar panel 122 is disposed on the top surface 124 of the control unit 116. The solar panel 122 is weatherproof and is adapted to absorb solar energy to convert it into electric power stored in at least one battery 600. The electric power is used for operating the self-sustaining coin-operated mobile shower unit 100 without any external power supply.

The shower device 100 is portable and can be transported between different places. The base 126 of the shower unit 102 includes a plurality of grates 128 for draining water into a used water tank 130. The used water tank 130 stores the water for filtration through at least one filter 136 and reuse. In the preferred embodiment, the used water is treated through multiple filtration stages through the filter 136, including reverse osmosis, to purify the water potentially for reuse or safe disposal. After each use of the shower unit 102, a UV light 131 disposed in the shower unit 102 automatically activates to sanitize the shower unit 102 for providing hygiene for the next user.

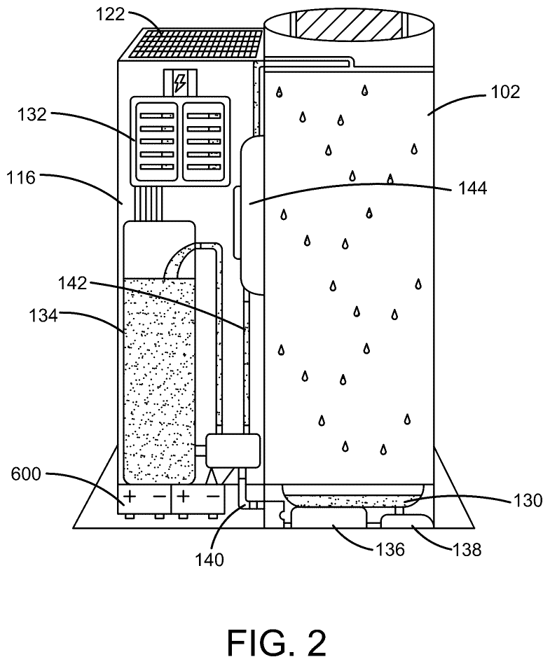

FIG. 2 illustrates a perspective view showing the inner connections between different components of the coin-operated shower device 100 of the present invention in accordance with the disclosed structure. The control unit 116 includes a wall mounted water heater 132 for heating the water stored in a fresh water tank 134. The water heater 132 operates using the electrical power generated by the solar panel 122 and stored in the battery 600, and is connected to the fresh water tank 134. The fresh water tank 134 is adapted to received filtered water from the used water tank 130. A reverse osmosis filter 136 is included in the device 100 for filtering the used water and is coupled with one or more pressure devices 138 for pressurizing water to transfer the water to the fresh water tank 134.

A first conduit 140 carries filtered water from the filter 136 to the fresh/clean water tank 134 and a second conduit 142 carries the water from the fresh water tank 134 to the shower head 114. The water from the fresh water tank 134 via the conduit 142 also passes through a second filter 144 for providing additional filtering to maintain hygiene for a user. The second filter 144 can be one or a combination of sediment filter and carbon filter. It will be apparent to a person skilled in the art that the filtering of the used water is automatically performed in real-time by the device 100. Preferably, when the device 100 is installed for the first time, fresh water is filled in the fresh water tank 134 and then, the same water can be reused multiple times before disposing off.

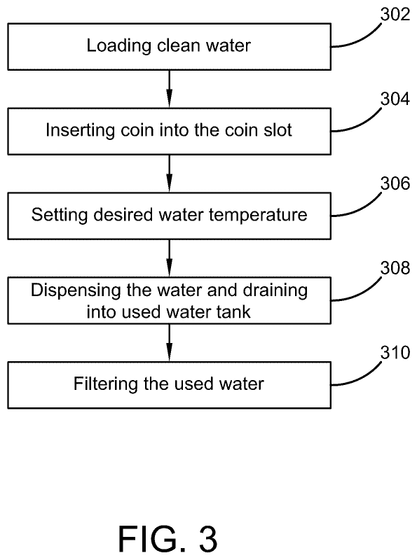

FIG. 3 illustrates a flow chart depicting a process of operation of the self-sustained portable coin-operated shower device of the present invention in accordance with the disclosed structure. Initially, the device 100 is loaded with clean water either manually or can be connected to a water source which fills the clean water tank [Step 302]. Then, for accessing the device 100, a coin is inserted into the coin slot to unlock the shower unit door and to allow access of the device 100 to take a shower [Step 304]. Thereafter, a desired water temperature is selected by the user using the water temperature control 112 [Step 306]. A user can then shower within the unit 102, wherein the shower operates for a predetermined set duration or until the water supply is depleted and water used for the shower drains through floor grates into the used water tank [Step 308]. The used water is then pumped through different filters to either prepare the water for reuse or for safe disposal [Step 310].

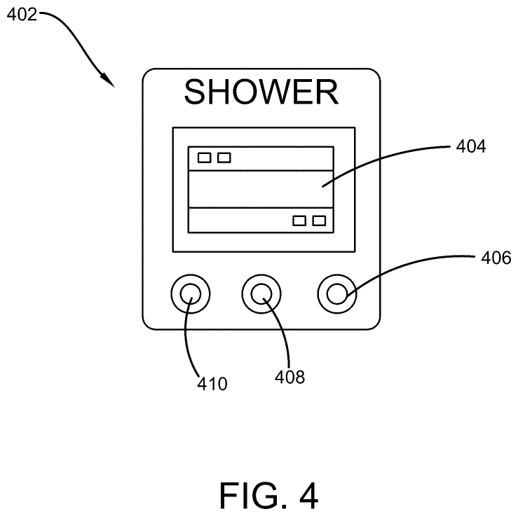

FIG. 4 illustrates a perspective view of another coin operated access unit which can be integrated to the self-sustaining coin-operated mobile shower unit in accordance with the disclosed structure. In the present embodiment, the coin operated access unit 402 includes an electronic display 404 configured to display real-time status of water level in the fresh water tank 134. The display 404 enables a user to check whether the water within the tank 134 is enough for a shower. A biometric access button 406 is included for providing biometric access after coin insertion operation in the device 100. The button 406 prevents unauthorized users from using the device 100 even when a coin is inserted in the coin slot. A filter status LED 408 is disposed in the unit 402 and is adapted to illuminate in a first color when the filters of the device 100 are functional and may illuminate in a second color which is different from the first color when one or more filters require replacement. A power button 410 disables the coin operated access unit 402 and prevents the device 100 from being used and can be used during transportation of the portable self-sustained coin-operated shower system 100. Also, in some embodiments, the coin operated access unit 402 is automatically disabled when the UV light is activated, to prevent a user from exposure of the UV light.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-sustaining coin-operated mobile shower unit”, “portable self-sustained coin-operated shower device”, “shower device” and “device” are interchangeable and refer to the portable self-sustained coin-operated shower device 100 of the present invention.

Notwithstanding the forgoing, the portable self-sustained coin-operated shower device 100 of the present invention can be of any suitable size and configuration as is known in the art without affecting the overall concept of the invention, provided that it accomplishes the above stated objectives. One of ordinary skill in the art will appreciate that the portable self-sustained coin-operated shower device 100 as shown in the FIGS. are for illustrative purposes only, and that many other sizes and shapes of the portable self-sustained coin-operated shower device 100 are well within the scope of the present disclosure. Although the dimensions of the portable self-sustained coin-operated shower device 100 are important design parameters for user convenience, the portable self-sustained coin-operated shower device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable self-sustained coin-operated shower device comprising:
a fresh water tank;
a coin operated access unit;
a filter; and
a shower unit comprised of:
a door;
a locking mechanism;
a shower head;
a water temperature control; and
a used water tank.

2. The portable self-sustained coin-operated shower device of claim 1, wherein the shower head is comprised of a fixed, adjustable shower head.

3. The portable self-sustained coin-operated shower device of claim 1, wherein the shower unit is comprised of a handrail.

4. The portable self-sustained coin-operated shower device of claim 1, wherein the shower unit is comprised of a folding seat.

5. The portable self-sustained coin-operated shower device of claim 1, wherein the shower unit is comprised of an LED light.

6. The portable self-sustained coin-operated shower device of claim 1, wherein the shower unit is comprised of a UV light.

7. A portable self-sustained coin-operated shower device comprising:
a fresh water tank;
a battery;
a solar panel;
a coin operated access unit;
a first filter; and
a shower unit comprised of:
a door;
a locking mechanism;
a shower head;
a water temperature control; and
a used water tank.

8. The portable self-sustained coin-operated shower device of claim 7, wherein the shower head is comprised of a detachable shower head.

9. The portable self-sustained coin-operated shower device of claim 7, wherein the filter is comprised of a reverse osmosis filter.

10. The portable self-sustained coin-operated shower device of claim 7, wherein the shower unit is comprised of a ventilated material.

11. The portable self-sustained coin-operated shower device of claim 7 further comprised of an electronic display.

12. The portable self-sustained coin-operated shower device of claim 7 further comprised of a first conduit attached to the filter and to a fresh water tank.

13. The portable self-sustained coin-operated shower device of claim 12 further comprised of a second conduit attached to the fresh water tank and to the shower head.

14. The portable self-sustained coin-operated shower device of claim 7 further comprised of a second filter.

15. The portable self-sustained coin-operated shower device of claim 14, wherein the second filter is comprised of a sediment or a carbon filter.

16. The portable self-sustained coin-operated shower device of claim 7 further comprised of a grate.

17. The portable self-sustained coin-operated shower device of claim 7, wherein the coin operated access unit is comprised of a coin slot.

18. The portable self-sustained coin-operated shower device of claim 7 further comprised of a water heater.

19. The portable self-sustained coin-operated shower device of claim 7 further comprised of a biometric access button.

20. A method of using a portable self-sustained coin-operated shower device, the method comprising the steps of:
loading a clean water tank of the portable self-sustained coin-operated shower device with an amount of clean water;
inserting a coin into a coin slot of the portable self-sustained coin-operated shower device to unlock a door of the portable self-sustained coin-operated shower device;
selecting a water temperature via a water temperature control of the portable self-sustained coin-operated shower device; and
showering within the portable self-sustained coin-operated shower device.
